(19) United States
(12) Patent Application Publication
(10) Pub. No.: US 2006/0067296 A1
(43) Pub. Date: Mar. 30, 2006

(54) Predictive tuning of unscheduled streaming digital content

(75) Inventors: Brian Nathan Bershad, Seattle, WA (US); Gaurav Ravindra Bhaya, Sunnyvale, CA (US)

Correspondence Address: LAW OFFICES OF RONALD M ANDERSON, 600 108TH AVE, NE, SUITE 507, BELLEVUE, WA, 98004, US

(73) Assignee: University of Washington, Seattle, WA (US)

(21) Appl. No.: 11/195,089

(22) Filed: Aug. 1, 2005

Related U.S. Application Data
(60) Provisional application No. 60/607,370, filed on Sep. 3, 2004.

(51) Int. Cl. H04L 12/28

(52) U.S. Cl. 370/351

(57) ABSTRACT

A predictive tuning system enables a user to easily and efficiently find desired digital content among a plurality of content streams. Using a data collector, analyzer, and distributed tuning service, users may specify one or more particular items of interest, and the system, through the use of predictive algorithms, determines a subset of the plurality of content streams that should be monitored in order to optimize along one or more dimensions, such as the length of time that the user must wait in order to receive their desired digital content. Various strategies can be employed to find the desired content in the data streams, and a combination of strategies can provide the most efficient approach to achieving the desired content. Once found, a desired content can be accessed contemporaneously, stored for later access, or can be input to another application.

### RELATED APPLICATIONS

This application is based on a prior copending provisional application Ser. No. 60/607,370, filed on Sep. 3, 2004, the benefit of the filing date of which is hereby claimed under 35 U.S.C. § 119(e).

### FIELD OF THE INVENTION

This invention generally pertains to a method and system that enables users to easily and efficiently find desired labeled digital content among a plurality of content streams, and more specifically, to a system and method that identifies a subset of the plurality of content streams that should be observed to optimize along one or more dimensions in order to detect the desired digital content within the subset.

### BACKGROUND OF THE INVENTION

A wide variety of digital content, including audio, video, and news, can be found on hundreds of thousands of continuous Internet data streams. In some domains, such as audio, licensing restrictions prevent streams from publishing their schedules in advance. In others, stream content may capture real-world activities that are themselves unscheduled. Regardless, the lack of a schedule coupled with the number of streams that are available makes it extremely difficult for users to quickly find specific streaming content that they desire. One approach to finding desired content in a system in which it might appear on any of a vast number of data streams would be to simply scan through the data streams until the desired content is detected. However, this approach could be very inefficient, particularly if the desired content is provided on only a very few data streams or is only infrequently provided on the plurality of streams. Clearly, a more effective approach is needed.

Content locality appears to be an important key for solving this problem. Content locality is the property that content within a stream is repetitive. Repetitive content enables future predictions to be made based on past behavior, which yields two advantages when searching for content. First, content locality should reveal the streams that are most likely to produce a positive result soonest, and which should therefore be closely monitored. Second, content locality should reveal the streams that are unlikely to produce a positive result, and should therefore be ignored. The first advantage should enable content to be found quickly, while the second should enable the content to be found efficiently.

Several classical mechanisms have been developed for exploiting locality. The problem bears a resemblance to the classical paging problem. Monitoring a stream corresponds to maintaining a cached copy of a page. A song occurring in a stream corresponds to a page request. A stochastic model that might be applied to solving this problem would correspond to that employed in frequency-based paging models. For the simplest of these, the Least Frequently Used (LFU) replacement policy appears to be optimal. However, the problem to be solved is much harder than simply paging, for the following reasons:

1. more than one cached element can satisfy a given request;

2. more than one request type can be satisfied by a cached element; and

3. the value of a cached element decreases on a hit, i.e., further occurrences of the same song may not be as appealing as one not yet heard.

The first two differences mean that there is a combinatorial aspect to this problem that is not present in paging. These differences alone make the problem Non-deterministic Polynomial (NP)-hard, since the problem encompasses the cover of a set of requests. The third difference means that it is not sufficient for the approach that is used to simply learn and adapt to the distribution of play frequencies as LFU adapts to a sequence of page requests by counting references. The target changes, based on the observed realization of the stochastic model, leading to a second combinatorial explosion. The best configuration is different in each of an exponential number of possible futures.

There is an extensive body of related work in prediction of access patterns for prefetching data based on past behavior, ranging from simply detecting sequential file accesses, as discussed by R. Feiertag and E. Organick, in “The Multics Input/Output System,” Proceedings of the 3rd Symposium on Operating Systems Principles, pages 35-41, 1971, to information-theoretic analysis, as discussed by K. Curewitz, P. Krishnan, and J. Vitter in “Practical prefetching via data compression,” Proceedings of the 1993 ACM Conference on Management of Data (SIGMOD), pages 257-266, May 1993. In “Automatic i/o hint generation through speculative execution,” Proceedings of the 3rd Symposium on Operating Systems Design and Implementation (OSDI), February 1999, F. Chang and G. A. Gibson consider the speculative execution of an application's code to generate prefetch hints. A separate thread executes the code in advance using its own copy of the application's state. I/O requests made by this thread are recorded but not performed and passed as hints to a prefetching cache manager. The speculating thread may make mistakes, of course, due to missing data that are not yet fetched from disk or are not yet computed correctly in the ordinary execution of the application. However, it should be useful to simulate strategies using past history in place of missing future data.

### SUMMARY OF THE INVENTION

Accordingly, an exemplary method is described for finding desired labeled data within a plurality of streams of labeled data that are accessible over a network. The method includes the step of identifying a plurality of sources of the labeled data accessible over the network. A history indicating specific labeled data that have been included in streams provided by the plurality of sources over a period of time is provided, and based upon the history, a subset of the plurality of streams of labeled data that are likely to include the desired labeled data is determined. The subset of the plurality of streams of labeled data is then monitored to detect when any of the desired data are included therein, and an indication is provided when any portion of the desired labeled data is detected in the subset of the plurality of streams of labeled data.

The method can include the step of providing a list of the desired labeled data for use in the step of monitoring the subset of the plurality of the streams of labeled data. The list of the desired labeled data is subsequently revised to exclude all portions of the desired labeled data that have already been detected, and the last three steps of the method discussed above are successively repeated to detect other portions of the desired labeled data that have not yet been detected, until no more desired labeled data remains to be detected.

The step of providing a history can comprise the step of creating a database that indicates the specific labeled data that have been included in the streams provided by the plurality of sources, can comprise the step of sampling the plurality of streams of labeled data over the period of time, to develop the history.

In one or more embodiments, the desired labeled data comprise a plurality of different desired labeled data objects. The step of determining the subset of the plurality of streams of labeled data that are monitored then comprises the step of selecting streams of labeled data that most quickly convey a maximum number of labeled data objects included in the different labeled data objects that are desired. In one or more other embodiments, after monitoring the streams of labeled data selected as most quickly conveying the maximum number of the labeled object included in the different labeled data objects that are desired for a period of time, the method further includes the step of changing and starting to instead monitor streams of labeled data selected as most likely to include any labeled object of the different labeled data objects that are desired. The change in the streams of labeled data that are monitored occurs when an expected coverage of the different labeled data objects that are desired has been maximized.

In other embodiments, the desired labeled data comprise a plurality of different desired labeled data objects, and the step of determining the subset of the plurality of streams of labeled data that are monitored comprises the step of selecting streams of labeled data that most frequently play a subset of more preferred desired labeled data objects from the plurality of different desired labeled data objects.

In yet other embodiments, the desired labeled data comprise a plurality of different desired labeled data objects, and the step of determining the subset of the plurality of streams of labeled data that are monitored comprises the step of selecting streams of labeled data that are most likely to include any of the different labeled data objects that are desired.

In an initial application of the method, the streams of labeled data comprise steams of audio data, and the labels identify the audio data.

Optionally, where permitted by copyright, the method can further include the step of enabling a user to store the desired labeled data that are detected, so that the desired labeled data that are thus stored may subsequently be played.

As a further option, a user may be enabled to selectively set a scope for monitoring the plurality of streams of labeled data so as to efficiently cover the plurality of streams of labeled data.

Another aspect is directed to a medium having machine instructions for carrying out the steps of the method discussed above. Still another aspect of the invention is directed to a system for finding desired labeled data within a plurality of streams of labeled data that are accessible over a network. On example of this system includes a network interface for communication over the network, a memory in which machine instructions are stored, and a processor that is coupled to the network interface and the memory. The processor executes the machine instructions that are stored in the memory to carry out a plurality of functions that are generally analogous with the steps of the method discussed above.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram showing the architecture of an exemplary embodiment of a data turbine, wherein a collector gathers history information from the set of available streams, a chooser suggests streams that a client should monitor according to a set of target identifiers (keys), a tuner closely monitors the suggested streams until a desired target is found, and a player presents the target to a user;

FIG. 2 is a graph illustrating a probability that a stream includes a title at least once more, given that it has already played it N times;

FIG. 3 is a graph of percentage requests satisfied for four different desired sets of titles, with a coverage over a seven day period and using an optimal strategy (i.e., a strategy that knows which stream is going to play one of a plurality of desired titles at the earliest);

FIGS. 4A-4D are exemplary graphs of percentage requests satisfied for four different desired sets of titles, with a coverage at the end of 12 hours, for various strategies using different playlists and a range of scopes;

FIGS. 4E-4H are exemplary graphs of percentage requests satisfied for four different desired sets of titles, with a coverage at the end of seven days, for various strategies using different playlists and a range of scopes;

FIG. 5 is an exemplary graph of the percentage requests satisfied for a predicted coverage, as a function of scope for the hybrid strategy and iTunes 100;

FIG. 6 is an exemplary graph of percentage requests for coverage over seven days for Blues100, using a scope of 50;

FIG. 7 is an exemplary graph of percentage requests, showing that similarity between streams can beneficially be exploited to find “rare” content;

FIGS. 8A and 8B are exemplary graphs of percentage requests satisfied for sampling using a HYBRID strategy at scope 50, for iTunes100 and Blues100;

FIG. 9 is a block diagram of an exemplary embodiment of a radio turbine;

FIG. 10 is an exemplary user interface for managing playlists with the radio turbine;

FIG. 11 is an exemplary running log of stream activity, wherein a small speaker icon next to a title indicates that a desired title was found and vectored to a user's player;

FIG. 12 is an exemplary user interface showing a more detailed view of stream activity, wherein scanning bars along the bottom illustrate a status of each of a number of scanning threads, and a message box indicates an expected waiting time until the next title from the playlist is found;

FIGS. 13A-13D are exemplary graphs of percentage requests satisfied for a predicted and measured coverage of the radio turbine for the various playlists using the stream greedy (SG) strategy and a scope of 50;

FIG. 14 is a flowchart illustrating the logical steps carried out in the present invention;

FIG. 15 is a schematic diagram of a conventional personal computer (PC) suitable for practicing the present invention; and

FIG. 16 is a schematic block diagram showing some of the functional components that are included within the processor chassis of the personal computer shown in FIG. 15.

### DESCRIPTION OF THE PREFERRED EMBODIMENT

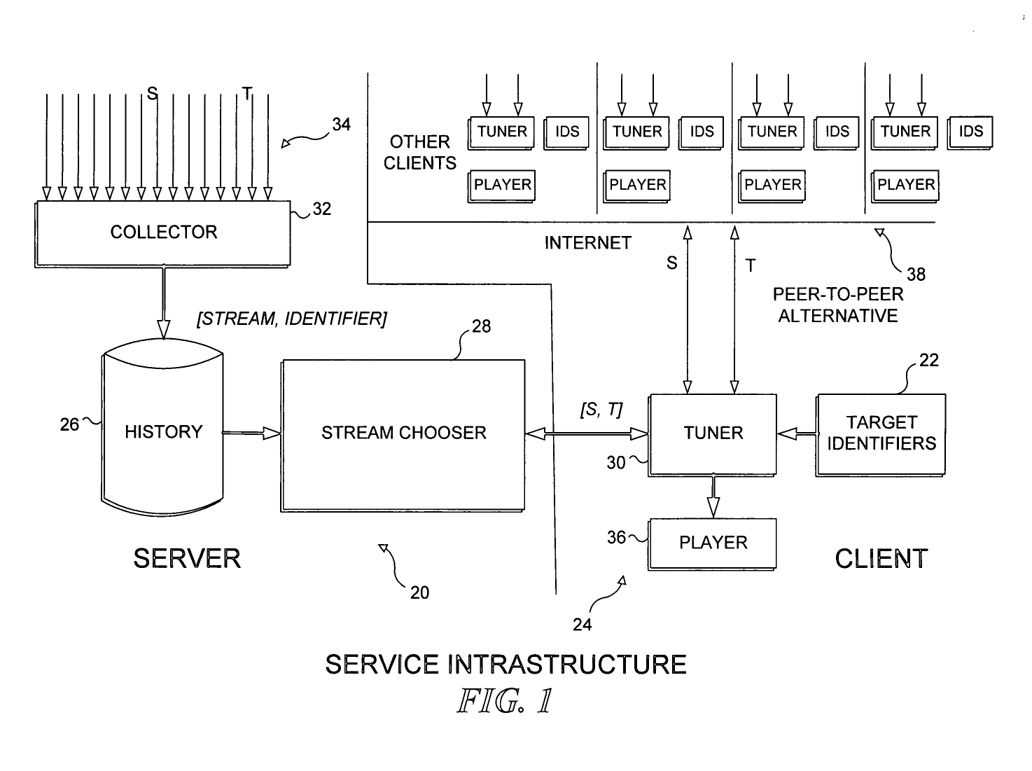

A Data Turbine is a term used in the following description for a system that exploits content locality to find identified content within a large number of unscheduled, continuous data streams. FIG. 1 illustrates one exemplary approach to structuring a Data Turbine. Functionality is partitioned within a client/server architecture. A server 20, given a list of targets 22 by a client 24 and a history 26 of streaming activity, employs a stream chooser 28 to select a small set of streams likely to provide the targets in the future. Each stream, S, is associated with an identifier, T. The history is gathered by server 20 using a collector 32 that monitors streams 34. A tuner 30 in the client closely monitors the selected set of streams. When one of the targets or titles desired by the user appears on a monitored stream, the client presents the stream's contents to the user, for example, by supplying the stream to a player 36. Alternatively, the stream can be recorded on a hard drive or other non-volatile storage medium (not shown in this Figure) for later play by the user. Other equivalent exemplary designs are contemplated for carrying out this functionality, such as a peer-to-peer structure that collaboratively manages the history and selects streams in connection with a plurality of similar clients 38. The focus of the following discussion is less on the specific way in which the functionality is partitioned and achieved, and more on the behavior of that functionality.

The Data Turbine offers a general model for finding streaming content. Different stream types, such as audio or Really Simple Syndication (RSS), though, may behave differently and require different implementations. Two Data Turbines have been reduced to practice to date, including an RSS Turbine and Radio Turbine, both according to the architecture of FIG. 1. The first is designed for the many RSS feeds that have recently exploded onto the Internet. The second, which is the embodiment used in connection with achieving the results discussed below, enables users to find music across any one of the 100,000-plus publicly available Internet radio streams. When a desired song is found, it can be played in real-time, or stored to disk and played later.

Content Locality

It will be shown that Internet radio streams exhibit a high degree of content locality, which is a key aspect of identifying desired titles within a plurality of data streams. In order to characterize Internet radio streams, 68 days' worth of streaming activity on the streams cataloged by a major Internet streaming clearinghouse were recorded. To help users discover streams, the clearinghouse publishes the name and last song played by Internet radio streams having software configured to report this information. A “scraper” was created to continuously pull this information from the clearinghouse and store it in a trace file. Table 1 (below) summarizes some basic statistics from the trace, and demonstrates the following points:

Choice: Internet radio streams deliver a substantial amount of content at a high rate. In just over 2 months, over three million unique titles were observed amongst 28 million songs played.

Spread: Any given stream delivers only a small fraction of the available titles. The most diverse stream offered only about 2% of the titles. No single title appeared on more than 3% of the streams. Although not shown in the table, it is estimated that it would take over 71,000 streams to cover all titles.

Locality: A stream that has played a title in the past is likely to play it again. More than 56,000 streams repeated at least one title, and over half the titles (1.65 million) were repeated by at least one stream.

TABLE 1
Statistics collected for Internet radio streams over a period of 68
days˜A “title” represents the name of a particular song, and a “play”
represents its occurrence on a stream.

| Start Date | Jul. 12, 2004 | |
|---|---|---|
| Days | 68 | |
| Unique Streams | 118,253 | |
| Total Songs Played | 28,626,788 | |
| Unique Titles | 3,179,013 | |
| Max. Titles with Repeated Plays | 74,125 | (2% of Titles) |
| Unique Titles with Repeated Plays | 1,947,931 | (61% of Titles) |
| Unique Titles with Repeated Plays | 1,650,822 | (52% of Titles) |
| on Same Stream | | |
| Titles That Were Played by | 2,035,404 | (64% of Titles) |
| Exactly One Stream | | |
| Max. Number of Streams | 3,626 | (3% of Streams) |
| for Any Title | | |
| Streams That Played Titles Not Played | 71,535 | (60% of Streams) |
| by Any Other Stream | | |
| Streams That Repeated Titles Not | 34,957 | (30% of Streams) |
| Repeated by Any Other Stream | | |
| Plays That Repeated a Song on a | 18,951,912 | (66% of Plays) |
| Stream That Played It Earlier | | |

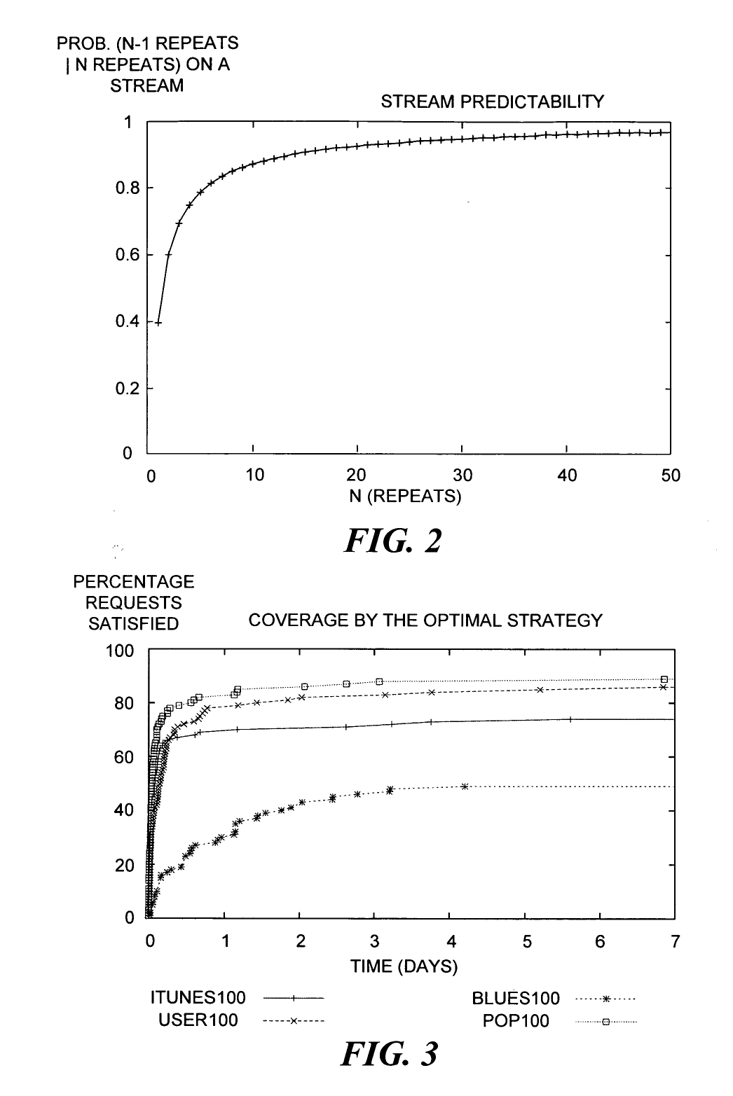

FIG. 2 shows that once a stream plays a given title just a few times, the likelihood of it playing it again is large. Consequently, a stream that more frequently plays a given title may be a better search candidate than one, which plays it less frequently. This result is not surprising and mirrors the natural searching strategy of someone looking for their favorite song on a car radio. In the next section, this natural strategy is examined in connection with the Internet, where there are many more streams, but it is possible to “listen” to more than one stream at a time.

Strategies for Predicting Streams

In this section, the following problem is examined: given a large set of streams, each carrying identifiable but unscheduled content, and a set of identifiers naming specific targets, find the largest number of targets in the shortest possible time. The problem is made difficult by the fact that receiving a stream has a cost. Using trace-driven simulation, a set of stream prediction strategies is evaluated in terms of their coverage and cost. Each strategy takes as input a playlist containing one or more titles, a history of past streaming activity indicating the time and title of each song played, and a scope, which is the number of streams that a client is willing to monitor. A large scope may increase coverage, but also increases the monitoring cost. Each strategy is evaluated according to its coverage, which is the fraction of desired titles found by a given point in time. This metric is aligned with a user's goal of finding desired titles. In addition, each strategy is compared against the optimal one, which has future knowledge of stream activity, i.e., the optimal strategy identifies the stream that is going to play one of the desired songs before any other stream does. In this way, any room for improvement within each strategy is apparent. Overall, it is shown that:

For a relatively short-term search (less than a day), the best strategy is to greedily search for the most frequently occurring items.

A greedy strategy can fail to find less popular items, but a hybrid strategy, which first searches for all titles and then becomes greedy, can locate less popular items.

For a large scope, the choice of strategy makes little difference, as all the strategies approach the optimal result. (Consider that an infinite scope would yield the same coverage as the optimal strategy).

Rarer content can be found more quickly by searching streams that have carried the content in the past and streams that carry similar content.

Before describing the strategies themselves, the following intuition about their behavior will become more apparent from a brief illustrative analogy.

Illustrative Analogy—The Hungry Fisherman

Imagine a tribe living in a forest that has thousands of fish-filled rivers. Every day, the members of the tribe go out to catch certain fish for supper. An evening's recipe calls for only one fish of each kind, so there is no need to catch the same kind twice. As all are expert fishermen, there is no reason to place more than one tribesman at a river at a time. No more tribesmen should be dispatched than is necessary to fill out the menu. Finally, the tribe has access to an almanac that describes the fish that have recently been seen in the rivers. The tribe uses that almanac to decide where to send the fishermen.

Over time, the tribe has experimented with a number of fishing strategies. In the beginning, they used a fish-greedy strategy, and sent everybody to the rivers where the most popular fish had most frequently been seen. Once the most popular fish was caught, the fishermen moved on to the rivers most frequently carrying the next most popular fish, and so on. In the event of a windfall catch, where an outstanding fish was unexpectedly caught, the fish was kept and no longer influenced the rest of the day's activities.

After a few days fishing, the tribe discovered that they caught many fish in the morning, but as the day wore on, they could not fill out the menu. They soon came to realize that it was wasteful to simultaneously send all the fishermen after the most popular fish, as these were plentiful and could be found by just a few tribesmen.

The tribe devised a second river-greedy strategy wherein the fishermen went to the rivers most likely to carry any of the fish on the menu, not just the most popular. For example, if one river carried bass and salmon, and another carried the more popular trout, the first river was visited first if the bass or salmon together were expected to occur more frequently than trout. As before, a windfall catch would be kept. This new strategy generally worked at least as well as the fish-greedy strategy in terms of menu coverage (the probability of finding any fish on the menu was found to be at least as great as that of finding the most popular). As with the first fish-greedy strategy, most of the action occurred in the morning with the catching of the popular fish, but there was little activity in the afternoon. By the end of the day, few unpopular fish had been caught.

Uninterested in fishing longer each day, and unwilling to send out more tribesmen, the tribe instituted a fish-cover strategy, working the set of rivers, which combined, had the greatest likelihood of yielding fish covering the menu. Here, the goal was to get all the fish needed for the menu in the long-run, not just the next easiest one. This new strategy gave the fishermen more time to catch the less popular fish. As a result, more of the less popular fish were caught. Unfortunately, the tribe was catching fewer fish overall than with the river-greedy strategy. By considering the hard-to-find fish all along, some fishermen were sent to rivers not only unlikely to yield an unpopular fish from the menu, but also less likely to yield any fish from the menu.

The river-greedy strategy was good for catching the easier fish quickly, but bad for catching all the fish, whereas the fish-cover strategy was good for catching all the fish but might fail in catching some of the easier ones. In light of this, the tribesmen created a hybrid strategy. For most of the day, tribesmen would use fish-cover to bring in the less popular fish while, at the same time, collecting windfalls (which often were the more popular fish). At some point during the day, they would switch to fish-greedy so as to quickly hook any outstanding easy-to-find fish. The optimal moment to switch fishing algorithms was that which maximized the day's expected coverage, i.e., to maximize the number of different kinds of fish on the menu caught. The tribe was able to compute this moment using the fishing almanac.

Radio Turbine Strategies

The fishing lessons can be applied to the problem of finding content in Internet streams. Clearly, fish are analogous to titles, rivers are analogous to data streams, menus are analogous to playlists, and the number of fishermen active in fishing is equivalent to scope. More formally, the data stream selection problem can be described using a bipartite graph, with titles in the playlist on one side and data streams on the other. There is an edge between title i and stream j, if j has played i at least one time. Edge (i, j) is labeled (weighted) by the frequency with which j plays i. Let S denote scope. Consider the following strategies, each of which only searches for titles not yet found, is reapplied after each title is found, and accepts windfalls:

Title-greedy (TG): This strategy selects the set of streams that most frequently play the most frequently played outstanding item from the playlist. In terms of the bipartite graph, TG selects the title with the largest sum of weights of incident edges. It then finds the S largest of these weights and chooses the corresponding streams. If fewer than S streams are identified, the strategy is rerun against the remaining streams using the next most popular item.

Stream-greedy (SG): Rather than selecting for just the most popular item, SG chooses the set of streams most likely to play any title from the playlist. That is, Stream-greedy selects the S streams with the largest sums of weights of incident edges.

Title-cover (TC): Instead of greedily searching for the titles that are easiest-to-find, TC searches for as many titles as possible by selecting the set of streams that soonest cover the most number of items in the playlist. (TC is Set Cover.) Although NP-hard, it can be solved, using a well-known greedy heuristic, which chooses the stream with the largest degree in the bipartite graph. The stream and all adjacent titles are then removed from the graph. These titles are now considered “covered” by this stream and no longer need to be considered. This process is repeated until S streams have been selected or there are no more titles. Edge weights are used only to break ties.

Hybrid (HY): This strategy begins with coverage as the focus, starting out with TC. At some point, it gives up on coverage and instead gives into greed as it switches to SG. As previously mentioned, the switch occurs when the expected coverage assuming a switch at that point is maximized. The history database is used to estimate the expected coverage given the titles found so far.

Results

A trace-driven simulation was used to evaluate the coverage produced by each strategy against the various playlists described below in Table 2. To drive both the strategies and the simulator, the traces of streaming activity described above were used. The trace was split into two parts—one for strategy history, and another for future streaming activity with which to evaluate the strategy. Except where noted, the strategies relied on seven days of prior history. To determine coverage, three different scope values were considered: small (5), medium (50) and large (500). For all the playlists, it was empirically determined that the large value represented the point of diminishing return.

TABLE 2
Playlists representing a variety of content used to evaluate stream
selection strategies.

| Playlist | Representing |
|---|---|
| BB50 | The Billboard Top 50 songs from week of Sept. 16, 2004 |
| Itunes100 | The top 100 songs purchased on the iTunes ™ Music |
| | Service during the week of Sept. 20, 2004 |
| Alternative100 | The top 100 songs from three genres purchased on the |
| Blues100 | iTunes ™ Music Service during the week of |
| Pop100 | Sept. 20, 2004 |
| User100 | A set of 100 songs selected at random from the 1000 |
| | most played songs on users' media players as |
| | reported by AutoScrobbler ™on Oct. 5, 2004 |

To illustrate any room for improvement with each strategy, Optimal (OPT), which selects the next stream that plays any outstanding title from the playlist, was also simulated. Optimal maximizes coverage, but requires future knowledge, making it useful only for comparative purposes. The results, shown in FIG. 3, give an upper bound on the coverage that can be obtained by any strategy. For three of the four playlists, approximately 80% of the titles appeared (i.e., were detected in the streaming data) by the end of the first day. The coverage for Blues100, though, was only about 25% by the end of the first day, and less than 50% by the end of a week. This playlist is poorly covered because it contains many rare titles. Moreover, of the 100 titles desired, only 61 titles appeared anywhere in the entire history.

Coverage

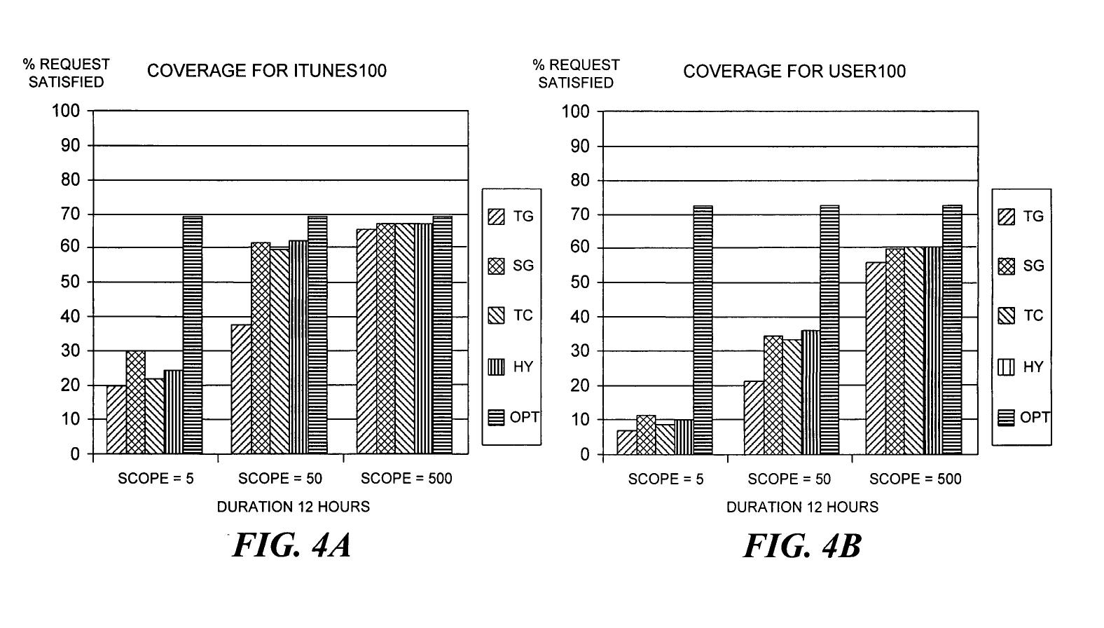

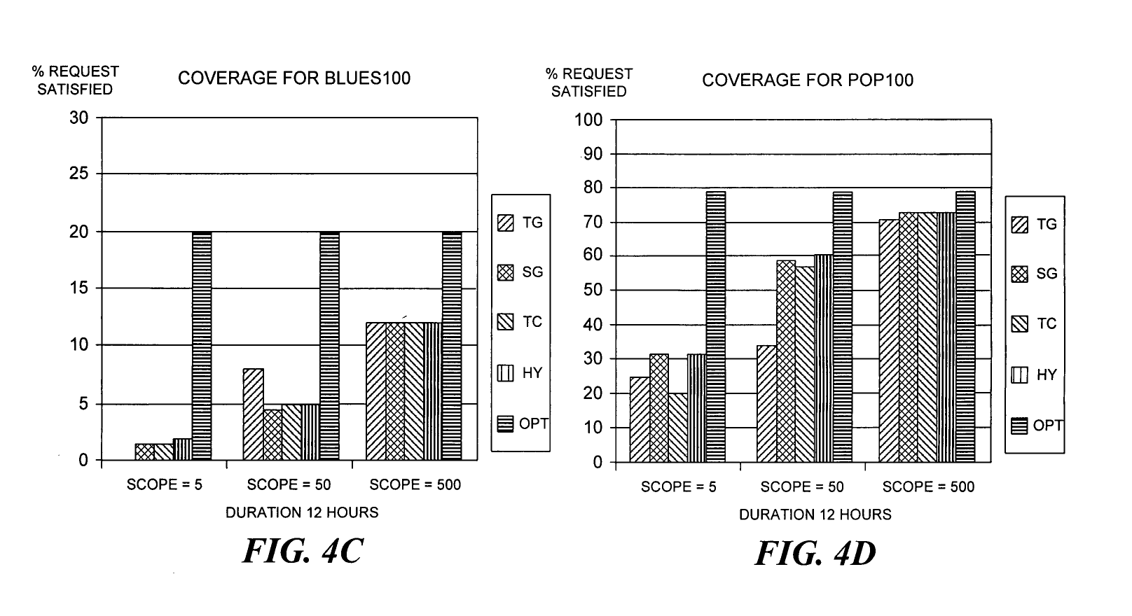

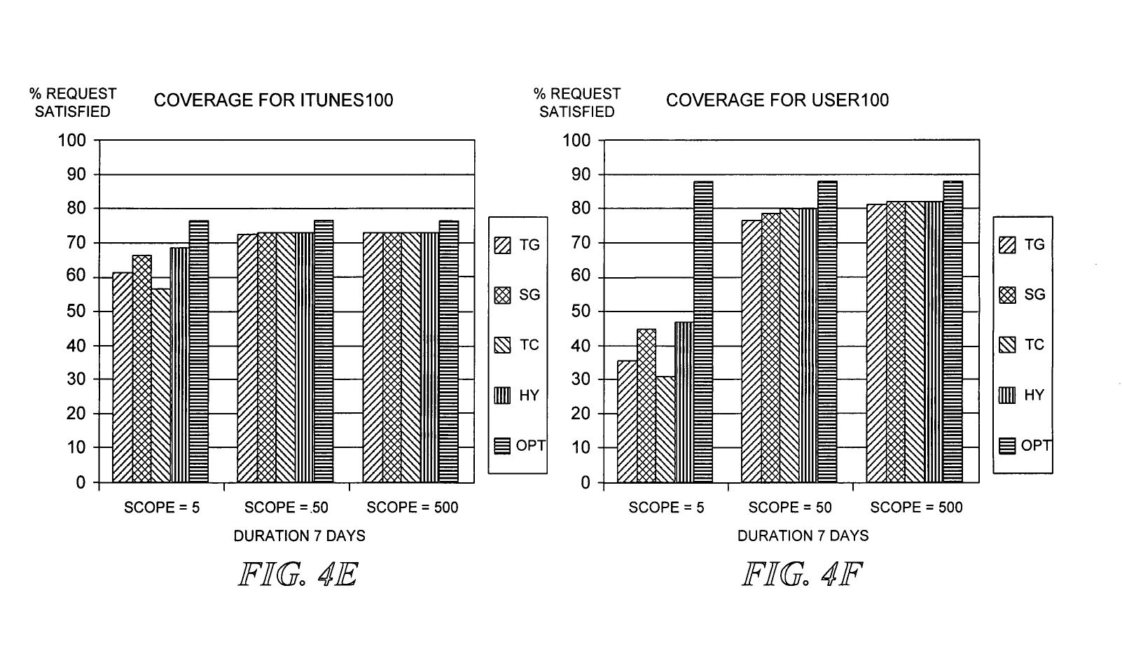

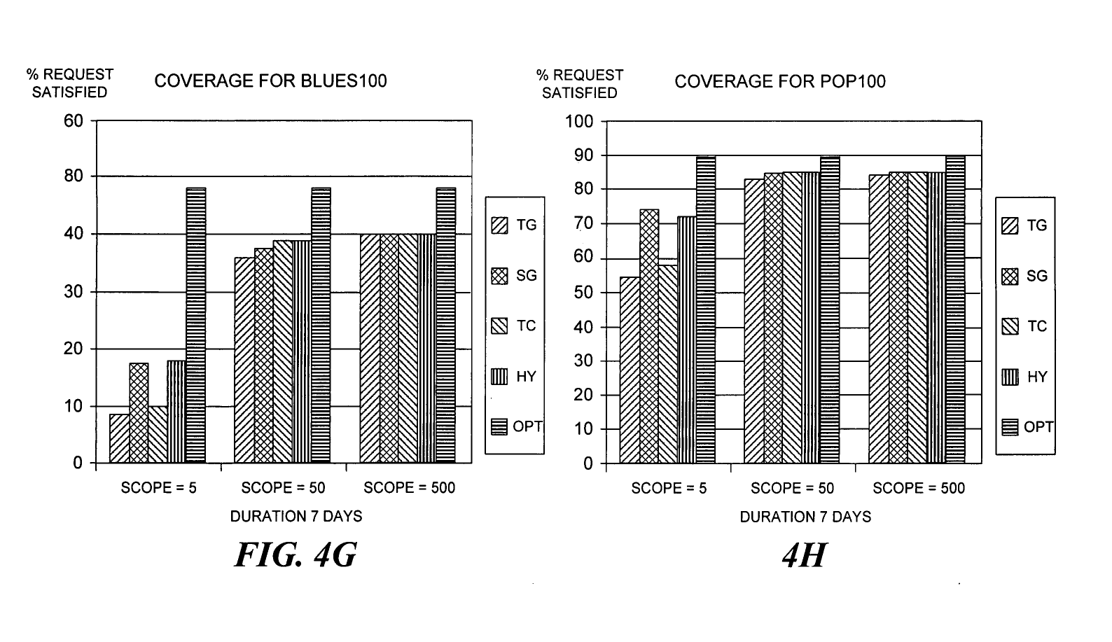

FIGS. 4A-4D present the coverage for the various strategies across the different playlists and scopes for 12 hours and FIGS. 4E-4H present the coverage for the various strategies across the different playlists and scopes for seven days, averaged across two independent runs with different data sets. As discussed above, the strategies exhibit the greatest differences at low scope when resources need to be carefully applied.

In nearly all cases, the worst-performing strategies are TG and TC, with neither clearly dominating the other. Recall that TG concentrates its effort on the most popular titles, whereas TC chooses a set of stations or data streams that together play as many desired titles as possible, without regard to the frequencies with which the desired titles occur. Neither can consistently yield as good results as the more moderate SG strategy. TG is occasionally slightly better and sometimes significantly worse than SG, because SG maximizes the sum of play rates over all titles in the play list rather than concentrating on just one title at a time, like TG. SG is sometimes much better, but never much worse than TC, because SG is willing to sacrifice titles that occur infrequently in order to increase the chance of finding more popular titles.

The various strategies differ in their collection of windfalls, which represent titles found “for free.” For TC, windfall accounts for much of the coverage at all scopes. For example, 23 titles are windfalls for the Pop100 playlist at scope 5. In contrast, Stream Greedy receives only 2 windfalls for the same playlist at scope 5. At higher scopes, though, it collects significant windfalls. TC receives windfalls by selecting stations which have a wide variety of titles even when scope is small, but SG chooses these stations only after focusing on the stations with more concentrated focus on fewer titles.

An advantage of TC's wide view is that it can be better at finding the less popular titles on a playlist. However, it occasionally gets blocked (for instance on Pop100 with scope equal to five) on a set of “variety” stations that fail to produce any titles in the playlist for quite some time.

Hybrid combines the wide coverage of TC with the greedy focus on high aggregate play rate of SG, giving it an opportunity to find less popular titles. For example, on the iTunes100 playlist with scope equal to five, Hybrid found four titles, all above the median in popularity in addition to all titles found by SG. On the Pop100 playlist with scope 50, Hybrid found the 86th most popular title in addition to all titles found by SG. However, “bottom feeding” sometimes degrades total coverage. For the Pop100 playlist with scope equal to five, for instance, Hybrid found one unpopular title at the expense of five more popular ones found by SG.

Determining Scope

Scope is essentially the only “dial” that a client can selectively set and use to influence coverage for a given playlist. Setting scope to a maximum improves coverage but may be wasteful, whereas setting it at too low a value may reduce coverage substantially.

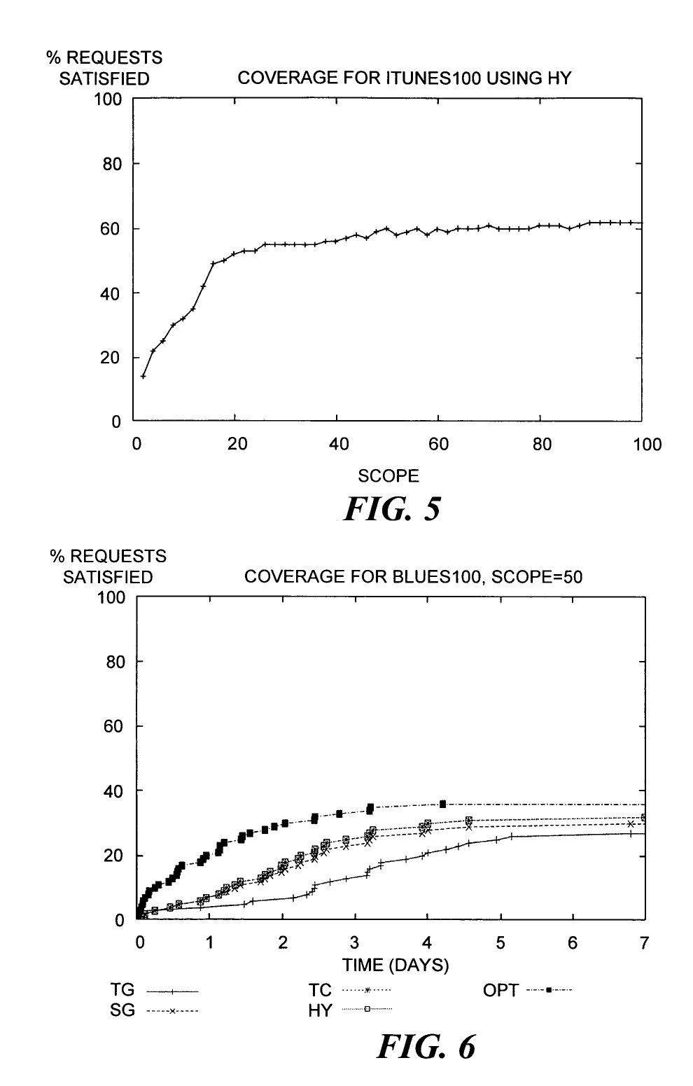

Fortunately, it is possible to predict the effect that scope will have on coverage for a playlist before searching starts. The prediction is done by simulating (on-line) the effect of a given strategy across a range of scopes using recent history as a proxy for the future. FIG. 5 illustrates that for one exemplary case, a scope of 20 to 25 offers the best tradeoff between coverage and cost. In an environment with severe bandwidth constraints, it may be necessary to use a lower scope, with client expectations being set by the example of FIG. 5.

Dealing with Rare Content

As is shown by Blues100, no strategy, is particularly good at finding extremely rare content. There are essentially three ways to increase coverage for rare content. First, the strategy can run for a longer period of time, giving more opportunities to find a rare item. As shown in FIG. 3, Optimal's coverage doubles to over 40% by the third day. The coverage of the other algorithms also increase substantially, as is shown in FIG. 6.

A second approach is to run the strategy with greater scope, thereby searching more streams simultaneously. Rare content, though, tends to be present on just a few streams, limiting the utility of additional scope. For example, with Blues100, the maximum number of streams predicted by any of the strategies was 181.

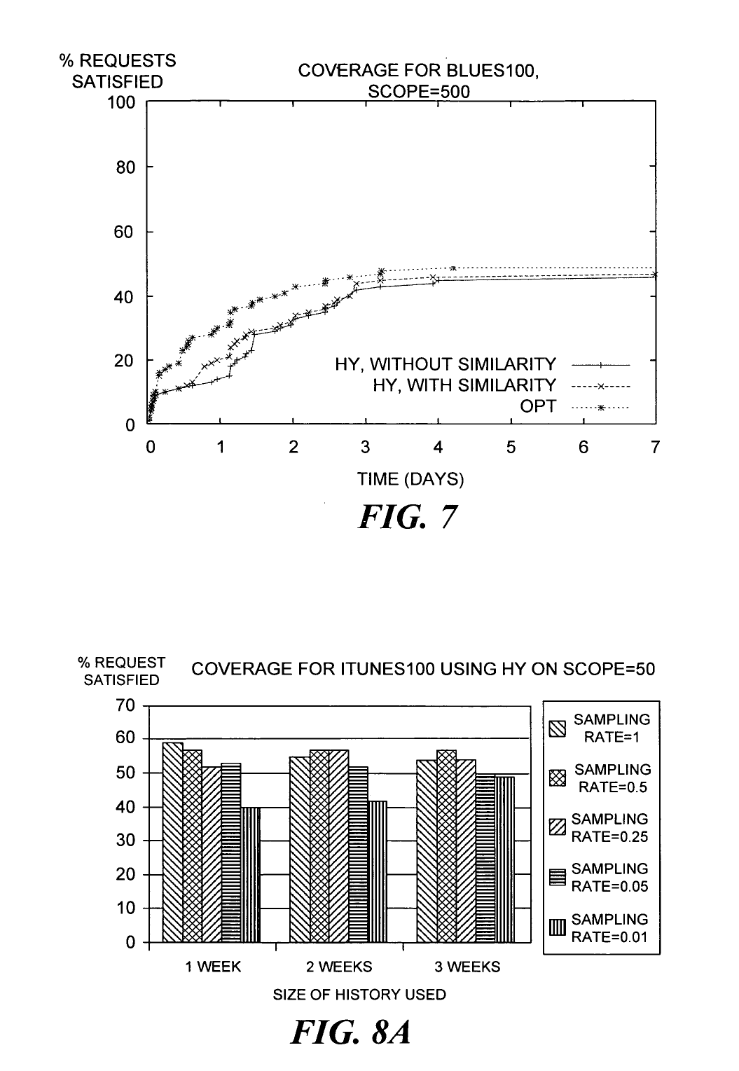

Instead, a third approach is to increase the number of streams monitored by including streams that have not yet been observed to play the desired title. The trick is to search streams not having played a certain target in the past, but substantially similar to other streams that have. This approach identifies an equivalence class of streams (like an on-the-fly genre), whose members have been observed to behave similarly. For example, if stream A has played titles (a, b, c), and stream B has played titles (a, b), then it is reasonable to expect that stream B may play c in the future. The similarity of any pair of streams can be quantified based on titles played, as a number between 0 (no titles in common) and 1 (every title in common). FIG. 7 shows that including similar streams when searching for rare content can increase coverage by several percentage points. In terms of the user's experience, each percentage point for this exemplary playlist of 100 titles corresponds to an additional found title.

History Sampling

As the number of streams increases, it may become difficult to maintain a complete history. For example, it currently takes us several minutes to scrape one stream clearinghouse, As we include additional clearinghouses, or they become larger or slower, it becomes necessary to sample. Sampling, though, may reduce the quality of the prediction strategies.

In order to determine the impact of sampling on coverage, we simulated our strategies using a sampled history database. We used relative sampling rates of 1, 0.5, 0.25, 0.05, and 0.01, where 1 corresponds to the complete database, 0.5 corresponds to sampling half as often, etc.

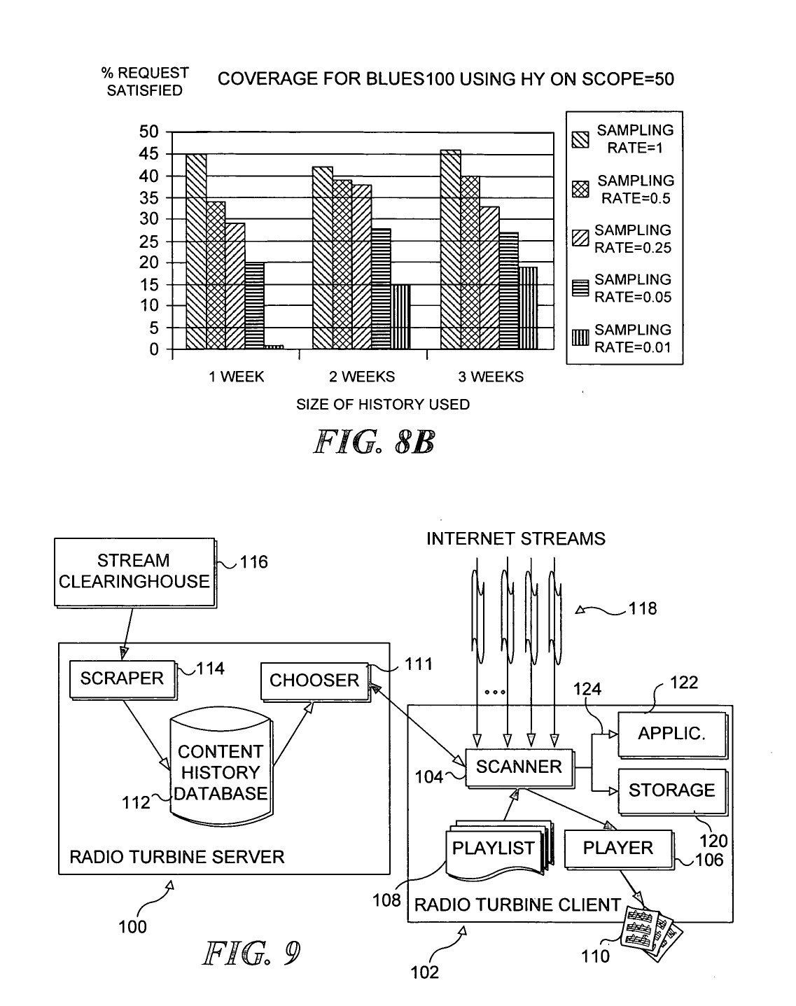

FIGS. 8A and 8B compare the coverage for Tunes100 (FIG. 8A) and Blues100 (FIG. 8B) for several sampling rates. With an extremely low (0.01) sampling rate and a short history coverage decreases substantially. At that rate, there are not enough samples within a week's time to produce good estimates of play frequencies. The impact of a slower sampling rate is far larger for Blues100 than for iTunes100. As mentioned earlier, Blues100 contains many rare titles. At low sampling rates, these titles have little representation in the history, and become even more difficult to find. FIGS. 8A and 8B also show that coverage of desired titles can be improved by sampling just as slowly, but for a longer period of time, because the underlying popularity distribution changes slowly.

### SUMMARY

In summary, both SG and Hybrid generally outperform the other strategies. SG is slightly better with respect to coverage. Hybrid is better at finding less popular items. Similarity further increases the likelihood of finding less popular items. Finally, all of the strategies are reasonably robust at reduced sampling rates.

Radio Turbine

The following discusses an exemplary embodiment of Radio Turbine, a software system that implements a Data Turbine for streaming Internet radio stations. This exemplary embodiment of Radio Turbine is a client-server system as shown in FIG. 9, which illustrates an exemplary radio turbine server 100 and an exemplary radio turbine client 102, each of which would comprises a computing machine. On each client machine is a scanner 104 and a player 106. The user creates one or more playlists 108 containing song titles 110 and submits them to the scanner. In turn, the scanner submits the playlist to a chooser 111, which runs on the radio turbine server, somewhere in the network. The radio server client can specify the scope it is capable of supporting or has determined represents the best compromise for a given set of circumstances. For example, by default, scope can be set to 50, which has been found appropriate for home broadband use, although other default values may be employed. For example, in situations where bandwidth is relatively limited, such as with a cell phone Internet modem, a lower scope may be used. In this embodiment, the chooser relies on a content history database 112 to identify and return to the client a set of streams likely to soon play the desired content. The database is maintained by a server-side scraper 114 that continuously gathers information about streaming activity from one or more stream clearinghouses 116 using the technique described above. An exemplary current implementation relies on the SG strategy, because insufficient benefit for using the Hybrid strategy was observed at the preferred scope to justify the additional implementation complexity.

The radio turbine client requires timely, accurate information about the streams it is monitoring. For this, in this embodiment, scanner 104 on the radio turbine client obtains the information directly from data streams 118 produced by Internet sources instead of monitoring using the scraped data from the radio turbine server. Although the scraper's data is adequate for predicting stream activity, it is insufficient for observing it in real-time. As mentioned above, scraper 114 may not observe every title within a stream. Moreover, the metadata can be stale by the time it is made available to the scraper by the stream clearinghouse.

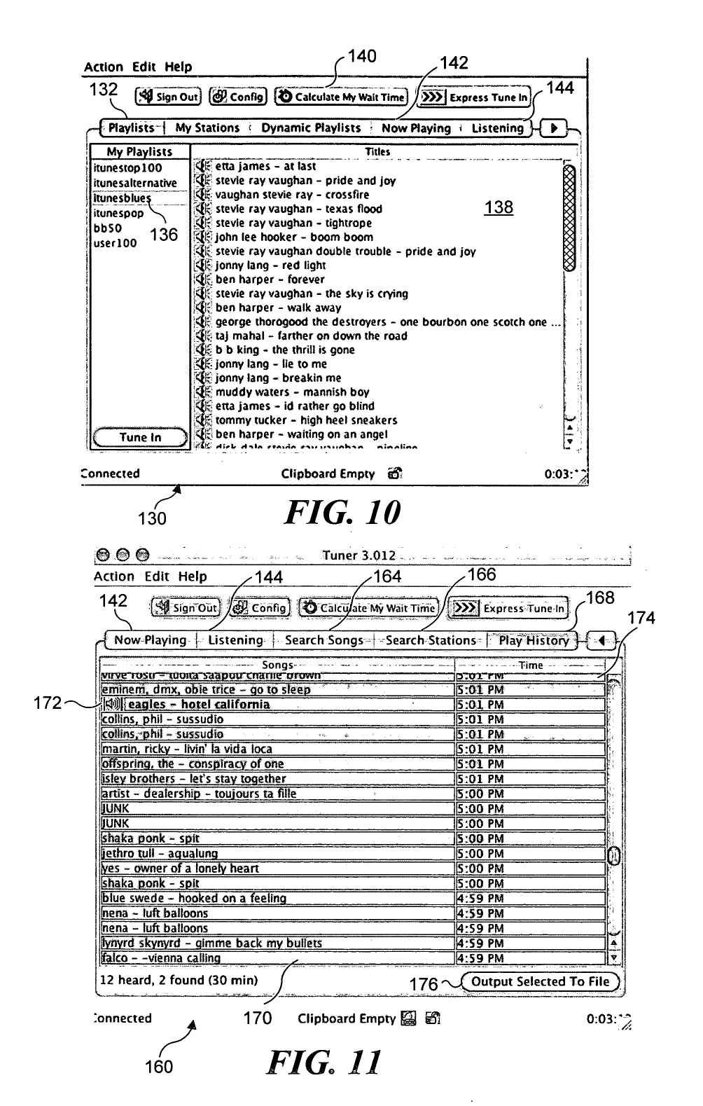

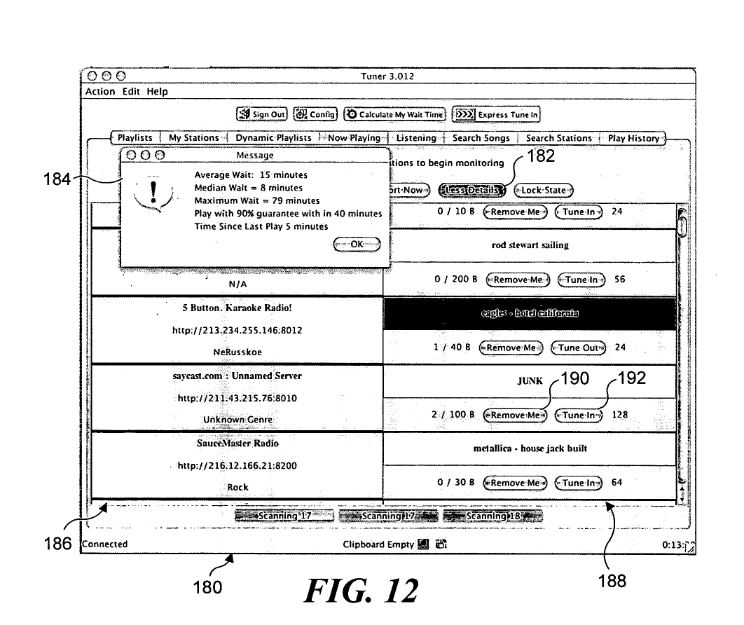

When scanner 104 identifies a target in one of the streams it is scanning, it relays the stream to player 106, which is a user-defined program that may play the song in real-time, record it to disk or other non-volatile storage 120, or relay it to another application 122 via a Transmission Control Protocol (TCP) connection 124. A simple graphic user interface can be provided to enable a user to manage playlists (as shown, for example, by an embodiment of a user interface 130 in FIG. 10), and monitor stream activity (see an exemplary interface 160 in FIG. 11). An exemplary “power interface” 180 in FIG. 12 provides the user with a deeper view into stream activity. These user interface examples are clearly only exemplary and are not in anyway intended to be limiting on the scope of the invention, since an almost infinite variety of interface screens could be employed to interact with labeled data objects, such as songs, that are conveyed within data streams.

Referring now to FIG. 10, user interface 130 includes several menu options, among which are included a currently selected Playlists option 132, which causes playlists 134 to be displayed, an option 142 identified as “Now Playing,” which can be selected to show the title that is currently playing, and an identified as Listening.” Since a playlist iTunesblues 136 is currently selected in playlists 134, a listing of all of the titles 138 included in iTunesblues 136 is displayed to the right of the playlists.

In FIG. 11, exemplary interface 160 for monitoring stream activity is illustrated. It also includes menu options 142 and 144, as well as a menu option 164, which can be selected to search for songs, a menu option 166 that can be selected to search for stations, and an option 168, which is currently selected and is identified as “Play History.” Option 168 causes songs that have been played or are being played by all of the data streams being monitored to be displayed in a window 170. A song 172 is currently being played, and the user is listening to it. The times of each song are displayed in a window 174. An option button 176 can be activated to store a currently selected file in a file within storage accessible by the user's computing device.

Exemplary power interface 180, which is illustrated in FIG. 12, can display either more details, as currently shown, or less details, if a menu option 182 is selected. A message box 184 is displayed in this example and provides statistics about the process for detecting desired titles in the streams being monitored, including (in regard to any desired title) the average wait time, the median wait time, the maximum wait time, the probability of play within a defined time interval, and the time since a last desired title was played. A window 186 lists the data streams being monitored by identifying name and provides details, including the Internet address of each and the genre of music played. A window 188 includes details of the songs being played on the data streams being monitored, including the artist and name of the song, bits in the data stream for the songs, and size of the song. Option buttons 190 and 192 on each listed song respectively enable the user to remove that title from the list or tune in to listen to the song or store it.

In order to reduce scanning bandwidth, the client scanner relies on two related optimizations when possible. First, when stream metadata, such as the current title, can be obtained directly from the streaming source without actually reading the stream, the scanner does so. As many streamcasters announce the current title out-of-band from the stream, scanning bandwidth is greatly reduced. Second, when multiple clients would otherwise be scanning the same stream, the chooser implements a protocol by which one client is designated the lead scanner for that stream. Once designated, the lead communicates the stream's metadata back to the server. From there, it is redistributed back to the remaining clients. In this way, the lead client's scanning directly benefits others. This second optimization is most appropriate in environments where clients can be trusted to cooperate, such as the home or small office.

Radio Turbine Performance

This section describes the performance of an exemplary Radio Turbine using the workloads and metrics discussed above and compares the actual behavior of the exemplary system with its predicted behavior. As well, the performance of Radio Turbine is compared against the Kazaa™ peer-to-peer network under an identical workload.

This embodiment of Radio Turbine client is implemented in Java, and can be run on any computer, but alternatively, could be implemented using any appropriate computer language. For the following experiments, Linux™ version 2.6.7 running on a Dell Corporation, OptiPlex GX400™ personal computer having an Intel Corporation 1.7 GHz Pentium 4™ processor, one GB of memory, and a gigabit network interface that links to the Internet via a 1 Gb/s broadband link. While running the experiments, no other applications were active on the system. It was determined that the processor or other system hardware components were not a bottleneck, by intermittently probing the system's load.

The results presented in this section demonstrate the following for this exemplary embodiment of the Radio Turbine:

Radio Turbine's behavior is consistent with the simulations presented earlier. It achieves good coverage across a range of playlists.

The Radio Turbine client uses only a few kilobytes per second of the available data stream capacity when monitoring data streams at moderate scope.

For identical playlists, this embodiment of the Radio Turbine is more effective at finding content than the Kazaa™ peer-to-peer network.

Coverage

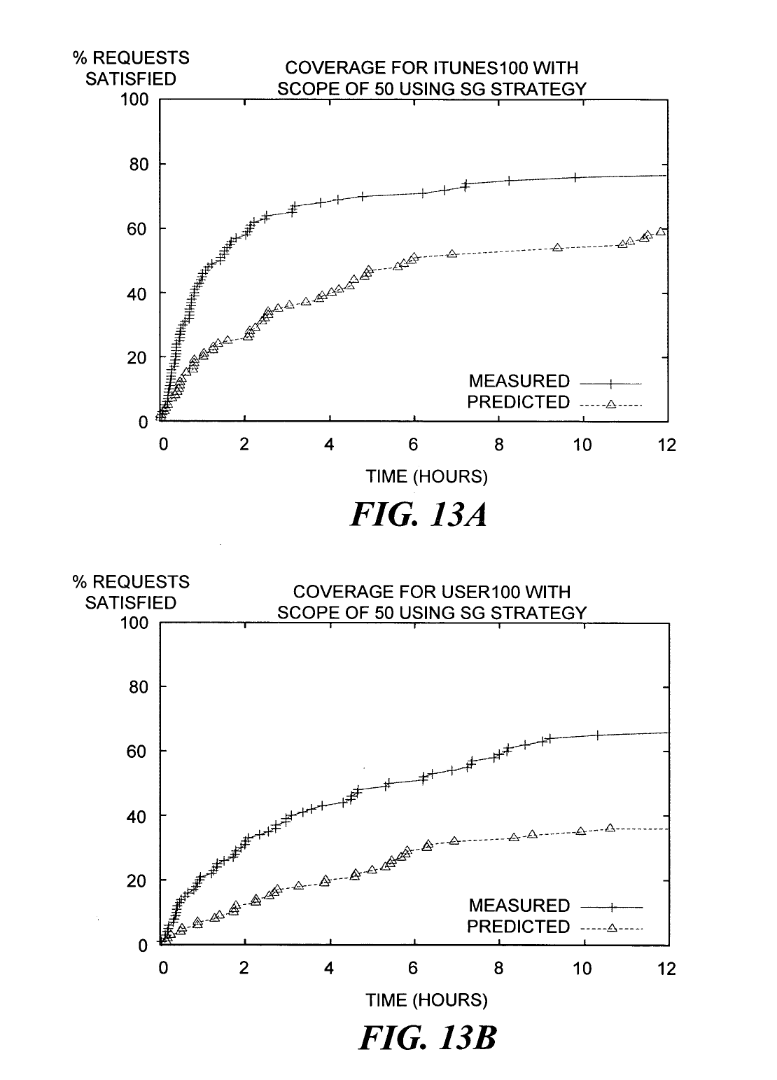

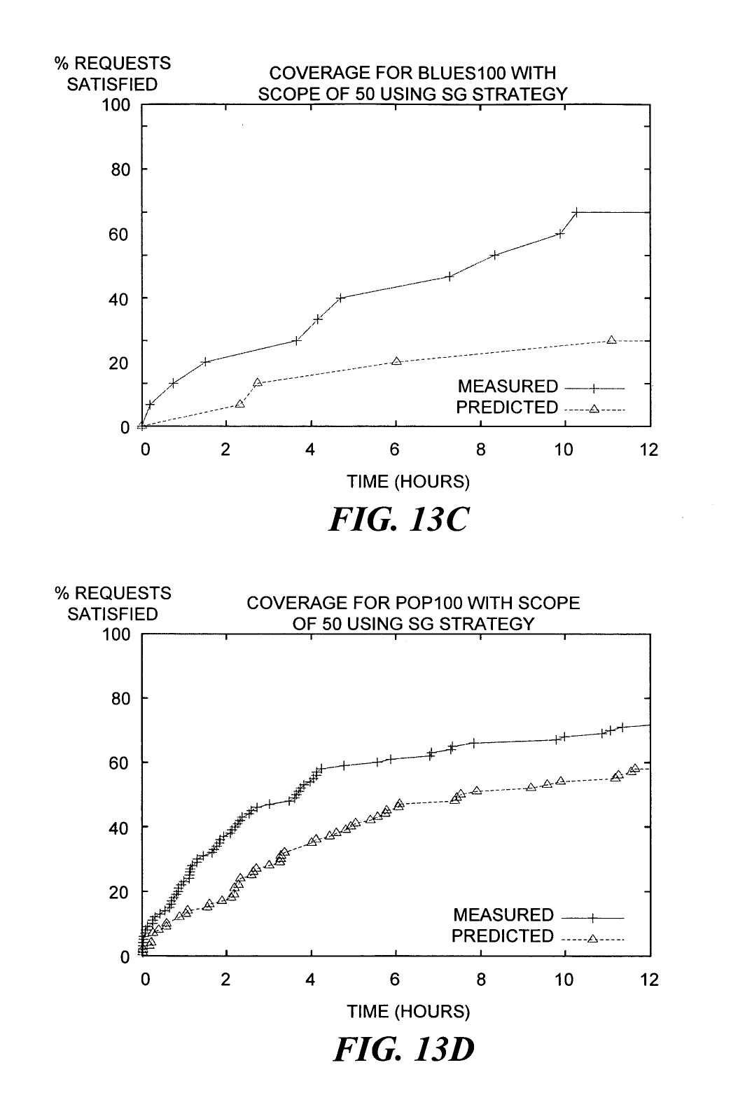

FIGS. 13A-13D shows the predicted and measured coverage over a 12-hour period for Radio Turbine using several playlists, the SG strategy, and a scope of 50. The graphs illustrate several points. First, in practice, Radio Turbine is able to deliver good coverage, finding about 80% of the requested titles within the time period for three of the playlists, 60% for two, and under 10% for, not surprisingly, Blues100.

Second, and somewhat counter-intuitively, the measured implementation achieves better coverage than was predicted by simulation. The reason for this can be found in our simulation trace, which tends to under-predict the coverage of the system. The simulation relies on the content history database both to predict the streams to scan, and to find a desired title that will occur in the future on one of those scanned streams. For the reasons described above, the history database may not capture all activity, because the scraper is not guaranteed to witness all titles provided by the clearinghouse. When used as a prediction tool, “gaps” in the database have little impact, as we demonstrated in an earlier discussion on reduced sampling rates. However, when the database is used by the simulator as a trace, the gaps “hide” the titles that would otherwise be contained within them. Consequently, the simulator may not find certain titles that would otherwise have been found by the more timely client scanner. While this counts as a point against the accuracy of our simulations, it does illustrate the importance of separating the scraper, which may not be precise, from the scanner, which should be. Were each client scanner as imprecise as the scraper, measured and predicted performance would align, but the effectiveness of Radio Turbine would be diminished.

Third, FIGS. 13A-13D illustrate the rate with which Radio Turbine finds titles. For example, as shown in FIG. 13A, for the playlist, iTunes100, the Radio Turbine finds over half the desired content in just the first two hours, corresponding to more music than could actually be heard in that time. This example illustrates one reason why a user might choose to configure the Radio Turbine to record the desired songs that are found in storage, rather than just listening to them as they are found.

Bandwidth and Scope

During the time this exemplary embodiment of the Radio Turbine was run, the total network bandwidth consumed by both the client scanner and the server scraper was measured. For the radio turbine client, which was running with a scope of 50 and using the metadata scanning optimization described above, incoming network traffic was measured at about 6 KB/second, on average. This includes the traffic to both find the title and stream it into the player. Without the optimization, the incoming traffic would have been substantially larger—on the order of one MB/second (the exact number depends on the bandwidth of the stream, which can vary). On the radio turbine server side where the scraper runs, a relatively constant bandwidth of about 22 KB/second was measured.

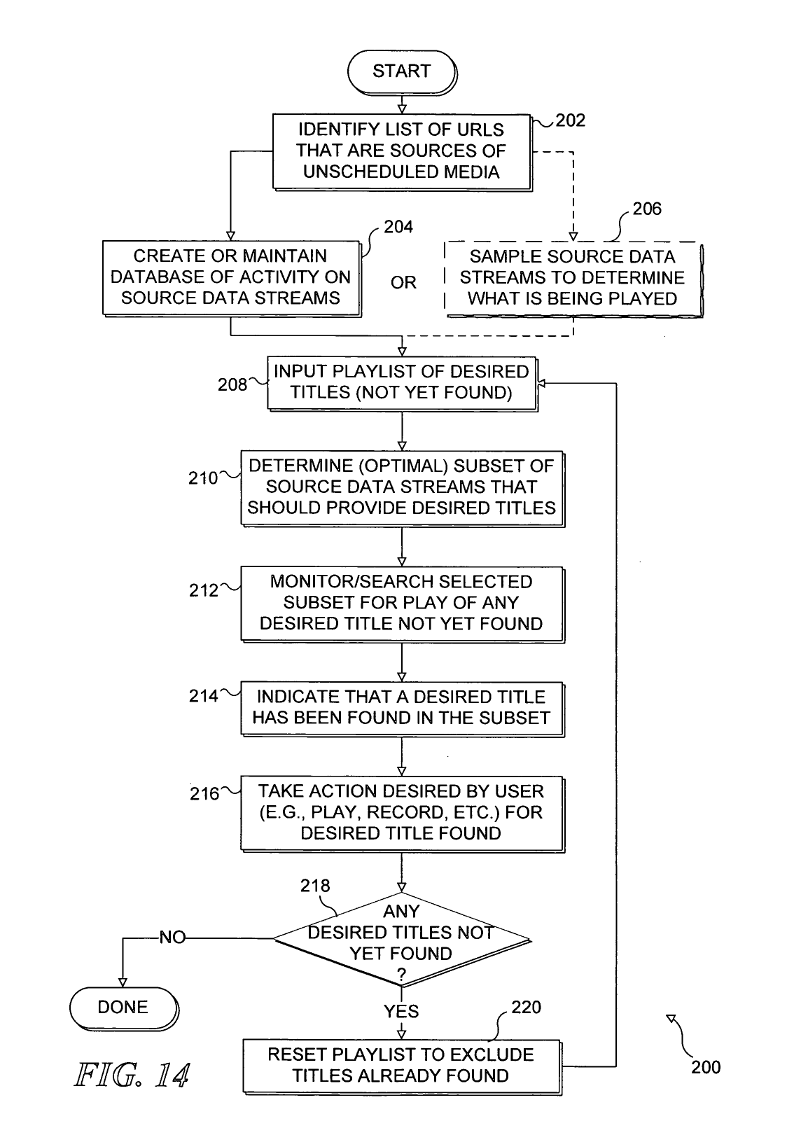

Logical Steps Implemented in the Radio Turbine (and Analogously, in the Data Turbine) FIG. 14 illustrates the logical steps of an exemplary flowchart 200 for carrying out the functionality of the Radio Turbine, and by analogy, the Data Turbine. A step 202 provides for identifying a list of URLs that are sources of unscheduled media, such as audio files. Clearly, appropriate sources of unscheduled media will vary, depending upon the nature of the media desired. In an initial exemplary application, the sources accessed in connection with the exemplary Radio Turbine are Internet radio stations that provide streaming audio files of music. However, in other applications, this technique can access other sources that provide different kinds of unscheduled media. For example, online news reporting services might be accessed using this invention, to obtain stories related to specific subjects or areas of interest. Accordingly, it is not intended that the present invention in any way be limited to accessing audio files that convey music, but can be applied for accessing almost any type of labeled objects that are provided in an unscheduled manner.

As shown in flow chart 200, a step 202 provides for identifying a list of potential sources of the unscheduled media. A step 204 provides for creating or maintaining a database indicating recent activity on sources of data streams. Such a database may be readily downloaded from a clearinghouse as noted above, but alternatively, may be independently compiled over time. Optionally, a step 206 indicates that the source data streams that were identified as potentially providing the media desired can be sampled to determine what is currently being played. Step 204 thus provides a historical reference indicating what has been played in the past by these sources of data streams, while optional step 206 provides contemporary data regarding the titles or other media content currently available on the data streams, from the sources identified.

A step 208 provides for input, typically by a user, of a playlist indicating the desired titles. Since this list will be redefined as titles on the original list are found, this step indicates that the playlist indicates titles not yet found. Initially, none of the desired titles will have been found, but as more of the desired titles are found, the playlist instead 208 will become shorter. A step 210 then determines a nominally optimal subset of source data streams that should provide the desired titles. Clearly, the historical information concerning the contents of the source data streams that is maintained in the database will provide an indication of the data streams that represent potential sources for acquiring the desired titles.

A step 212 provides for monitoring or searching the data streams in the selected subset to detect the play of any desired title that has not yet been found. A number of exemplary strategies are discussed above for carrying out this step, and as noted above, a hybrid strategy may often provide the best approach for detecting as many of the desired titles as rapidly as possible. As each desired title is found in the subset of source data streams being monitored or searched, a step 214 provides an indication. The indication may simply cause the desired title to be played as it is found, or alternatively, the indication may cause the desired title that was found to be automatically stored for later access or enjoyment by the user. Thus, a step 216 provides for taking an appropriate action desired by the user, such as playing, recording, or making the file available to a different application, for each desired title, as it is found. A decision step 218 determines if any of the desired titles remain to be found. An affirmative response leads to a step 220, in which case, the playlist may be reset to exclude all titles that were desired and which have already been found. The logic them loops back to step 208.

Personal Computer Useful for Practicing the Method

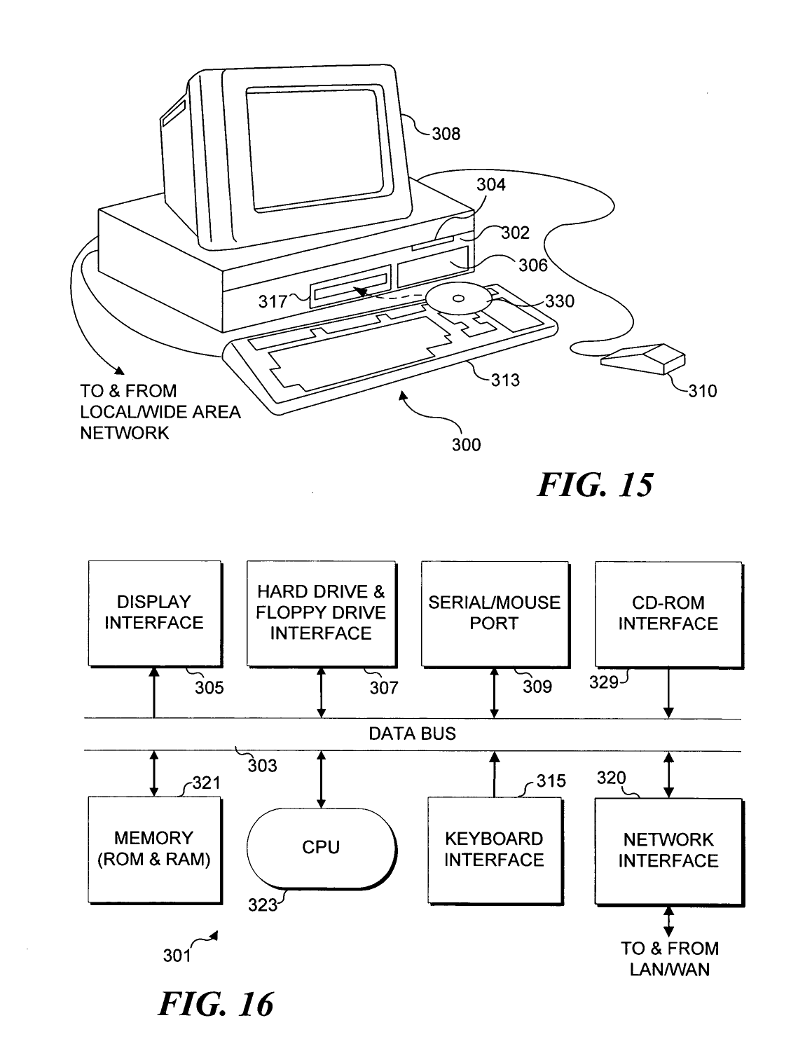

With reference to FIG. 15, a generally conventional personal computer 300 is illustrated, which is suitable for use in connection with practicing the present invention. Alternatively, a portable computer, or workstation coupled to a network, and a server may instead be used. It is also contemplated that the present invention can be implemented on a non-traditional computing device that includes only a processor, a memory, and supporting circuitry, and which can be coupled to a network or other data transfer medium.

Many of the components of the personal computer discussed below are generally similar to those used in each alternative computing device on which the present invention might be implemented; however, a server is generally provided with substantially more hard drive capacity and memory than a personal computer or workstation, and generally also executes specialized programs enabling it to perform the functions of a server. Personal computer 300 includes a processor chassis 302 in which are mounted a floppy disk drive 304, a hard drive 306, a motherboard populated with appropriate integrated circuits (not shown), and a power supply (also not shown), as are generally well known to those of ordinary skill in the art. A monitor 308 is included for displaying graphics and text generated by software programs that are run by the personal computer. A mouse 310 (or other pointing device) is connected to a serial port (or to a bus port) on the rear of processor chassis 302, and signals from mouse 310 are conveyed to the motherboard to control a cursor on the display and to select text, menu options, and graphic components displayed on monitor 308 by software programs executing on the personal computer. In addition, a keyboard 313 is coupled to the motherboard for user entry of text and commands that affect the running of software programs executing on the personal computer.

Personal computer 300 also optionally includes a compact disk-read only memory (CD-ROM) drive 317 into which a CD-ROM disk 330 may be inserted so that executable files and data on the disk can be read for transfer into the memory and/or into storage on hard drive 306 of personal computer 300. Personal computer 300 may be coupled to a local area and/or wide area network as one of a plurality of such computers on the network that access one or more servers that provide data streams of labeled content in an unscheduled manner.

Although details relating to all of the components mounted on the motherboard or otherwise installed inside processor chassis 302 are not illustrated, FIG. 16 is an exemplary block diagram showing some of the functional components that are included. The motherboard has a data bus 303 to which these functional components are electrically connected. A display interface 305, comprising a video card, for example, generates signals in response to instructions executed by a central processing unit (CPU) 323 that are transmitted to monitor 308 so that graphics and text are displayed on the monitor. A hard drive and floppy drive interface 307 is coupled to data bus 303 to enable bi-directional flow of data and instructions between the data bus and floppy drive 304 or hard drive 306. Software programs executed by CPU 323 are typically stored on either hard drive 306, or on a floppy disk (not shown) that is inserted into floppy drive 304. The software instructions for implementing the present invention will likely be distributed either on floppy disks, or on a CD-ROM disk or some other portable memory storage medium. The machine instructions comprising the software application that implements the present invention will also be loaded into the memory of the personal computer for execution by CPU 323. However, it is also contemplated that these machine instructions may be stored on a server and accessible for execution by computing devices coupled to the server, or might even be stored in ROM of the computing device.

A serial/mouse port 309 (representative of the two serial ports typically provided) is also bi-directionally coupled to data bus 303, enabling signals developed by mouse 310 to be conveyed through the data bus to CPU 323. It is also contemplated that a universal serial bus (USB) port may be included and used for coupling a mouse and other peripheral devices to the data bus. A CD-ROM interface 329 connects CD-ROM drive 317 to data bus 303. The CD-ROM interface may be a small computer systems interface (SCSI) type interface or other interface appropriate for connection to an operation of CD-ROM drive 317.

A keyboard interface 315 receives signals from keyboard 313, coupling the signals to data bus 303 for transmission to CPU 323. Optionally coupled to data bus 303 is a network interface 320 (which may comprise, for example, an ETHERNET™ card for coupling the personal computer or workstation to a local area and/or wide area network).

When a software program such as that used to implement the present invention is executed by CPU 323, the machine instructions comprising the program and which might be stored on a floppy disk, a CD-ROM, the server, or on hard drive 306 are transferred into a memory 321 via data bus 303. These machine instructions are executed by CPU 323, causing it to carry out functions as determined by the machine instructions. Memory 321 may include both a nonvolatile read only memory (ROM) in which machine instructions used for booting up personal computer 300 are stored, and a random access memory (RAM) in which machine instructions and data defining an array of pulse positions are temporarily stored.

It should be noted that the present invention can be used in other applications besides accessing streaming content on the Internet. For example, it would also be applicable to accessing desired content transmitted by various convention radio stations. It should be apparent that the discussion provided above in regard to use of this invention on the Internet makes is applicable to almost any medium on which content is provided in a manner that enables a history to be accumulated for the specific content provided.

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for finding desired labeled data within a plurality of streams of labeled data that are accessible over a network, comprising the steps of:
(a) identifying a plurality of sources of the labeled data accessible over the network;
(b) providing a history indicating specific labeled data that have been included in streams provided by the plurality of sources over a period of time;
(c) determining a subset of the plurality of streams of labeled data that are likely to include the desired labeled data;
(d) monitoring the subset of the plurality of streams of labeled data to detect when any of the desired data are included therein; and
(e) providing an indication when any portion of the desired labeled data is detected in the subset of the plurality of streams of labeled data.

2. The method of claim 1, further comprising the step of providing a list of the desired labeled data for use in the step of monitoring the subset of the plurality of the streams of labeled data.

3. The method of claim 2, further comprising the steps of:
(a) revising the list of the desired labeled data to exclude all portions of the desired labeled data that have already been detected; and
(b) successively repeating steps (c) through (e) of claim 1 to detect another portion of the desired labeled data that has not yet been detected, until no more desired labeled data remains to be detected.

4. The method of claim 1, wherein the step of providing a history comprises the step of creating a database that indicates the specific labeled data that have been included in the streams provided by the plurality of sources.

5. The method of claim 1, wherein the step of providing a history comprises the step of sampling the plurality of streams of labeled data over the period of time, to develop the history.

6. The method of claim 1, wherein the desired labeled data comprise a plurality of different desired labeled data objects, and wherein the step of determining the subset of the plurality of streams of labeled data that are monitored comprises the step of selecting streams of labeled data that most quickly convey a maximum number of labeled data objects included in the different labeled data objects that are desired.

7. The method of claim 6, wherein after monitoring the streams of labeled data selected as most quickly conveying the maximum number of the labeled object included in the different labeled data objects that are desired for a period of time, the method further comprises the step of instead monitoring streams of labeled data selected as most likely to include any labeled object of the different labeled data objects that are desired.

8. The method of claim 7, wherein a change in the streams of labeled data that are monitored occurs when an expected coverage of the different labeled data objects that are desired has been maximized.

9. The method of claim 1, wherein the desired labeled data comprise a plurality of different desired labeled data objects, and wherein the step of determining the subset of the plurality of streams of labeled data that are monitored comprises the step of selecting streams of labeled data that most frequently play a subset of more preferred desired labeled data objects from the plurality of different desired labeled data objects.

10. The method of claim 1, wherein the desired labeled data comprise a plurality of different desired labeled data objects, and wherein the step of determining the subset of the plurality of streams of labeled data that are monitored comprises the step of selecting streams of labeled data that are most likely to include any of the different labeled data objects that are desired.

11. The method of claim 1, wherein the streams of labeled data comprise steams of audio data, and wherein the labels identify the audio data.

12. The method of claim 11, further comprising the step of enabling a user to store the desired labeled data that are detected, so that the desired labeled data that are thus stored may subsequently be played.

13. The method of claim 1, further comprising the step of enabling a user to selectively set a scope for monitoring the plurality of streams of labeled data so as to efficiently cover the plurality of streams of labeled data.

14. A medium having machine instructions for carrying out the steps of claim 1.

15. A system for finding desired labeled data within a plurality of streams of labeled data that are accessible over a network, comprising:
(a) a network interface for communication over the network;
(b) a memory in which machine instructions are stored;
(c) a processor that is coupled to the network interface and the memory, the processor executing the machine instructions that are stored in the memory to carry out a plurality of functions, including:
(i) identifying a plurality of sources of the labeled data accessible over the network;
(ii) providing a history indicating specific labeled data that have been included in streams provided by the plurality of sources over a period of time;
(iii) determining a subset of the plurality of streams of labeled data that are likely to include the desired labeled data;
(iv) monitoring the subset of the plurality of streams of labeled data to detect when any of the desired data are included therein; and
(v) providing an indication when any portion of the desired labeled data is detected in the subset of the plurality of streams of labeled data.

16. The system of claim 15, wherein the machine instructions further cause the processor to enable a user to provide a list of the desired labeled data for use in the step of monitoring the subset of the plurality of the streams of labeled data.

17. The system of claim 15, wherein the machine instructions further cause the processor to:
(a) automatically revise the list of the desired labeled data to exclude all portions of the desired labeled data that have already been detected; and
(b) successively repeat functions (iii) through (v) of claim 15 to detect another portion of the desired labeled data that has not yet been detected, until no more desired labeled data remains to be detected.

18. The system of claim 15, wherein the machine instructions further cause the processor to provide the history by creating a database that indicates the specific labeled data that have been included in the streams provided bye the plurality of sources.

19. The system of claim 15, wherein the machine instructions further cause the processor to provide the history by sampling the plurality of streams of labeled data over the period of time, to develop the history.

20. The system of claim 15, wherein the desired labeled data comprise a plurality of different desired labeled data objects, and wherein the step of determining the subset of the plurality of streams of labeled data that are monitored comprises the step of automatically selecting streams of labeled data that most quickly convey a maximum number of labeled data objects included in the different labeled data objects that are desired.

21. The system of claim 20, wherein after monitoring the streams of labeled data selected as most quickly conveying the maximum number of the labeled object included in the different labeled data objects that are desired for a period of time, the machine instructions further cause the processor to instead monitor streams of labeled data selected by the processor as most likely to include any labeled object of the different labeled data objects that are desired.

22. The system of claim 21, wherein a change in the streams of labeled data that are monitored by the processor occurs when an expected coverage of the different labeled data objects that are desired has been maximized.

23. The system of claim 15, wherein the desired labeled data comprise a plurality of different desired labeled data objects, and wherein the processor determines the subset of the plurality of streams of labeled data that are monitored selecting streams of labeled data that most frequently play a subset of more preferred desired labeled data objects from the plurality of different desired labeled data objects.

24. The system of claim 15, wherein the desired labeled data comprise a plurality of different desired labeled data objects, and wherein the processor determines the subset of the plurality of streams of labeled data that are monitored by selecting streams of labeled data that are most likely to include any of the different labeled data objects that are desired.

25. The system of claim 15, wherein the streams of labeled data comprise steams of audio data, and wherein the labels identify the audio data.

26. The system of claim 25, wherein the machine instructions further cause the processor to enable a user to store the desired labeled data that are detected, so that the desired labeled data that are thus stored may subsequently be played.

27. The system of claim 15, wherein the machine instructions further cause the processor to enable a user to selectively set a scope for monitoring the plurality of streams of labeled data so as to efficiently cover the plurality of streams of labeled data.
